(19) United States
(12) Patent Application Publication
(10) Pub. No.: US 2012/0265637 A1
(43) Pub. Date: Oct. 18, 2012

(54) Systems And Methods For Facilitating Electronic Purchase Of A Product

(76) Inventor: Katherine Marie Moeggenberg, Silverton, OH (US)

(21) Appl. No.: 13/461,055

(22) Filed: May 1, 2012

Related U.S. Application Data
(62) Division of application No. 13/446,295, filed on Apr. 13, 2012.
(60) Provisional application No. 61/475,291, filed on Apr. 14, 2011.

(51) Int. Cl. G06Q 30/06

(52) U.S. Cl. 705/26.8

(57) ABSTRACT

Included are embodiments for facilitating purchase of a product. Some embodiments include determining, from first real-time inventory data, whether a first vendor that hosts the first vendor website currently maintains stock of the product, determining, from second real-time inventory data, whether a second vendor that hosts the second vendor website currently maintains stock of the product, and providing a purchase option in the product-user interface to purchase the product, where the purchase option comprises a list of vendors that currently maintains stock of the product, where the list of vendors excludes vendors that do not currently maintain a stock of the product.

### CROSS REFERENCE TO RELATED APPLICATION

This application is a divisional of U.S. application Ser. No. 13/446,295, filed on Apr. 13, 2012, which claims the benefit of U.S. Provisional Application No. 61/475,291, filed on Apr. 14, 2011.

### FIELD OF THE INVENTION

The present application relates generally to purchasing a product electronically and to systems and methods for providing vendor comparison, providing a mechanism for purchasing from a plurality of vendors, and/or providing cross-sell recommendations to a user.

### BACKGROUND OF THE INVENTION

As electronic commerce continues to develop, many users wish to purchase more and more products online. However, oftentimes many of the hurdles for purchasing online goods limit those purchases. A user may be viewing product advertisements online and may wish to purchase the advertised products. The user may then navigate to an online vendor to purchase the product. If the user is price-conscious, the user may navigate to multiple online vendors to determine the best price. The user may then add the desired product to a shopping cart and must then perform one or more actions to indicate a method of purchase, shipping address, etc. Because of the actions required to purchase the product, many users become frustrated and lose the impulse to purchase the product at that time. Oftentimes, the failure to purchase the product at that time ultimately results in the user not purchasing the product altogether. Either way, many users decide to forego the purchase. Thus, manufacturers and vendors experience a need to provide an improved online shopping experience to users that will result in the purchase being consummated.

Even in situations where the user purchases the product, the user oftentimes forgets of other products they may also wish to purchase, due to the organization of the online vendor. Similarly, in some situations, a user may purchase a first product and remembers a second product that the user wishes to purchase. However, in some situations, the vendor does not carry (or is out of stock) of the second product. As a consequence, the user is forced to start the online shopping process over for the second product. This often causes the user to decide against such a purchase, and again, the manufacturer or vendor experience a need to provide an improved online shopping experience to the user.

### SUMMARY OF THE INVENTION

Included are embodiments for facilitating the electronic purchase of a product. Some embodiments of a system and/or method include providing a product-user interface that comprises data regarding a product, collecting first real-time inventory data of the product from a first vendor website, and collecting second real-time inventory data of the product from a second vendor website. Similarly, some embodiments include determining, from the first real-time inventory data, whether a first vendor that hosts the first vendor website currently maintains stock of the product, determining, from the second real-time inventory data, whether a second vendor that hosts the second vendor website currently maintains stock of the product, and providing a purchase option in the product-user interface to purchase the product, where the purchase option comprises a list of vendors that currently maintains stock of the product, where the list of vendors excludes vendors that do not currently maintain a stock of the product.

Similarly, some embodiments of a system and/or method include providing a product-user interface that includes a first option to purchase a first product from a first vendor and a second option to purchase a second product from a second vendor, receiving a first user selection of the first option to purchase the first product from the first vendor, and in response to receiving the first user selection, providing a first cart window within the product-user interface. Some embodiments include receiving a second user selection of the second option to purchase the second product from the second vendor, in response to receiving the second user selection, providing a second cart window within the product-user interface, and providing, within the product-user interface, a first checkout option to complete purchase of the first product from the first vendor and a second checkout option to complete purchase of the second product from the second vendor. Some embodiments additionally include, in response to a user selection of the first checkout option, submitting user information to a first vendor website of the first vendor to complete purchase of the first product and in response to a user selection of the second checkout option, submitting user information to a second vendor website of the second vendor to complete purchase of the second product.

Still some embodiments of a system and/or method include providing a product-user interface that provides data related to a first product that is sold by a first vendor, receiving a user selection of the data related to the first product, and in response to receiving the user selection of the data related to the first product, determining a consumer characterization, the consumer characterization identifying a current state of a consumer. Still some embodiments include determining a second product that corresponds with the current state of the consumer, screen scraping real-time product data related to the second product from a website and provide the real-time product data in the product-user interface, with a purchase option to purchase the second product without navigating to the website.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for purchasing an online product, according to embodiments disclosed herein;

FIG. 2 depicts a web hosting computing device for facilitating purchase of an online product, according to embodiments disclosed herein;

FIG. 3 depicts a product-user interface for providing a product, according to embodiments disclosed herein;

FIG. 4 depicts a product-user interface for providing categories of products, according to embodiments disclosed herein;

FIG. 5 depicts a product-user interface for providing a plurality of products within a category, according to embodiments disclosed herein;

FIG. 6 depicts a product-user interface for providing a purchase option for purchasing a product, according to embodiments disclosed herein;

FIG. 7 depicts a product-user interface for providing a vendor option when purchasing a product, according to embodiments disclosed herein;

FIG. 8 depicts a product-user interface for providing a cart window for purchasing a product, according to embodiments disclosed herein;

FIG. 9 depicts a product-user interface for selecting a product for purchase, according to embodiments disclosed herein;

FIG. 10 depicts a product-user interface for providing a first cart window and a second cart window, according to embodiments disclosed herein;

FIG. 11 depicts a product-user interface for providing a single shopping cart for a plurality of vendors, according to embodiments disclosed herein;

FIG. 12 depicts a product-user interface for receiving shipping information from a user, according to embodiments disclosed herein;

FIG. 13 depicts a product-user interface for placing an order for a product, according to embodiments disclosed herein;

FIG. 14 depicts a product-user interface for publishing an advertisement on a webpage, according to embodiments disclosed herein;

FIG. 15 depicts a user interface for posting a shipment notification in a public message, according to embodiments disclosed herein;

FIG. 16 depicts a user interface for providing a purchase option in a public message, according to embodiments disclosed herein;

FIG. 17 depicts a user interface for providing a purchase option in a private message, according to embodiments disclosed herein;

FIG. 18 depicts a flowchart for providing an inventory comparison, according to embodiments disclosed herein;

FIG. 19 depicts a flowchart for facilitating a purchase from a plurality of vendors, according to embodiments disclosed herein;

FIG. 20 depicts a flowchart for providing cross product recommendation, according to embodiments disclosed herein; and

FIG. 21 depicts a flowchart for providing a product recommendation and promotion, according to embodiments disclosed herein.

### DETAILED DESCRIPTION OF THE INVENTION

Embodiments disclosed herein include systems and methods for providing an inventory comparison. Some embodiments are configured to provide a webpage or other product-user interface that provides products for purchase. The products may include any good and/or service that may be purchased online. The product-user interface may be provided by a manufacturer or other provider of the product and may be directly embedded into a manufacturer website, vendor website, and/or social networking website. Regardless, the product-user interface may provide an option to purchase the product from one of a plurality of vendors. The option to purchase the product from one of a plurality of vendors may be automatically customized, based on which vendors currently have stock of that product. More specifically, embodiments of the systems and methods may first determine which vendors have the product in stock, and provide a vendor list that excludes those vendors that do not currently have the product in stock.

Similarly, some embodiments are configured to provide a plurality of cart windows. More specifically, the product-user interface described above may provide options to purchase a plurality of different products. A user may select a first product to purchase and a first cart window may be provided. The user may then select a second product to purchase. In response to a determination that the second product is to be purchased from a second vendor, a second cart window may be provided, substantially concurrently with the first cart window. Additionally, in some embodiments, a single checkout option may be provided to facilitate purchase of both the first product and the second product.

Still some embodiments are configured for providing a cross-sell functionality. In some embodiments, the system and/or method may determine a consumer characterization that identifies a state of the consumer. The consumer characterization may include a physical characteristic, an emotional characteristic, a cognitive characteristic, and/or other characteristic, based on a product viewed and/or purchased. The determination of the consumer characterization may be made from previous purchases, previous web navigation, and/or other data. From the consumer characterization and/or user state, the system and/or method can determine a second product that the user may desire to purchase. In some embodiments, the second product may be in a different product category than the first product, such that it would not be readily apparent that the user would desire the second product. As an example, if the user is purchasing baby diapers, embodiments disclosed herein may recommend a cereal (such as toasted oats shaped like O-rings with a hollow center) that are fed to children as a meal or as snacks and owing to their hollow center are commonly believed to present less risk of choking hazard to small children than cereals lacking such a structural void.

It should be understood that the user may include a potential purchaser who is engaging in the actions disclosed herein. As an example, the user may be anyone who is using the system to view and/or purchase a product, such as the end-user of the product, gift giver who buys the product and intends it to be sent to an end-user caregiver who purchases a product, but does not intend to use it themselves, baby shower guests, etc. Separately, “consumers”, some of which may be “users” may include the ultimate end user of the product, (e.g., baby, a caregiver who assists another in using the product, etc.).

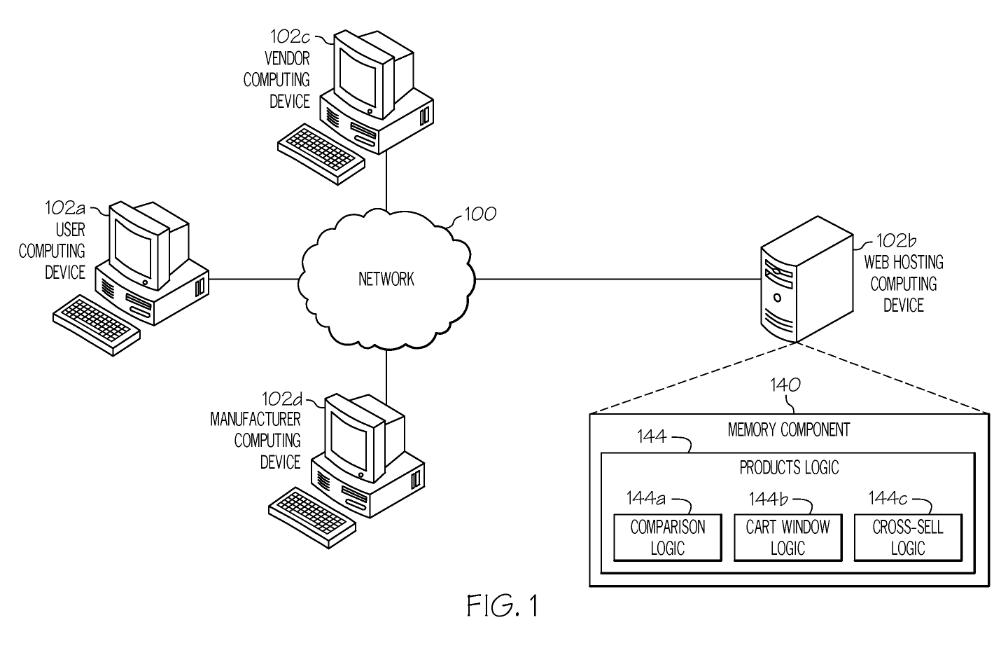

Referring now to the drawings, FIG. 1 depicts a computing environment for purchasing an online product, according to embodiments disclosed herein. As illustrated in FIG. 1, a network 100 may include a wide area network, such as the Internet, a local area network (LAN), a mobile communications network, a public service telephone network (PSTN) and/or other network and may be coupled to a user computing device 102a, a web hosting computing device 102b, a vendor computing device 102c, and a manufacturer computing device 102d. The web hosting computing device 102b may include a memory component 140 that stores products logic 144 for providing product purchasing functionality, as described in more detail below. Included within the products logic 144 is comparison logic 144a, cart window logic 144b, and cross-sell logic 144c.

As also discussed in more detail below, the products logic 144 may be configured to provide an interface for viewing and/or purchasing a product. The products logic 144 may be integral with a social network application, vendor website, manufacturer website, etc. and/or may be separate from but configured to operate with these systems. As part of the products logic 144, the comparison logic 144a may be configured to cause the web hosting computing device 102b to determine whether predetermined vendors currently stock a product. The comparison logic 144a may also cause the web hosting computing device 102b to provide options to purchase the product from a list of vendors, where only vendors that currently stock the product are included in the list. Depending on the particular embodiment, the list of vendors may be sorted according to price, consumer preference of vendors, previous user purchases, competitive promotions, and/or other criteria. Additionally, other criteria for filtering vendors may be used, such as by current price threshold, by current price per unit threshold, by quantity, previous user purchases, etc.

The cart window logic 144b may cause the web hosting computing device 102b to provide one or more cart windows for one or more respective vendors within a single interface. As discussed in more detail below, the interface may be a social network interface, product manufacturer website interface and/or other interface. In some embodiments, the cart window logic 144b may cause the web hosting computing device 102b to provide a single purchase option to facilitate a purchase from each vendor substantially simultaneously.

Similarly, the cross-sell logic 144c may cause the web hosting computing device 102b to determine a user characteristic from a product that the user viewed and/or purchased. From the user characteristic, the cross-sell logic 144c may cause the web hosting computing device 102b to determine a product that corresponds with that user characteristic. In some embodiments the determined product may be in a different product category than the product that the user viewed and/or purchased.

It should be understood that while the user computing device 102a, web hosting computing device 102b, the vendor computing device 102c, and the manufacturer computing device 102d are depicted as personal computers and/or servers, these are merely examples. More specifically, in some embodiments any type of computing device (e.g. mobile computing device, personal computer, server, etc.) may be utilized for any of these components. Additionally, while each of these computing devices 102 is illustrated in FIG. 1 as a single piece of hardware, this is also an example. More specifically, each of the computing devices 102-106 may represent a plurality of computers, servers, databases, etc.

It should also be understood that while the products logic 144 and related logic is depicted in the web hosting computing device 102b, this is also just an example. In some embodiments, the user computing device 102a, the vendor computing device 102c, and/or the manufacturer computing device 102d may include this and/or similar logical components.

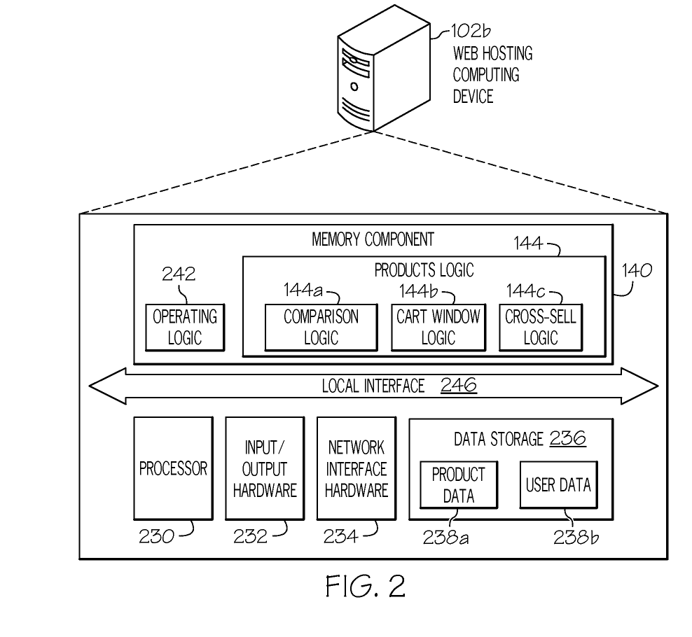

FIG. 2 depicts a web hosting computing device 102b for facilitating purchase of an online product, according to embodiments disclosed herein. In the illustrated embodiment, the web hosting computing device 102b includes at least one processor 230, input/output hardware 232, network interface hardware 234, a data storage component 236 (which includes product data 238a, user data 238b, and/or other data), and the memory component 140. The memory component 140 may be configured as volatile and/or nonvolatile memory and, as such, may include random access memory (including SRAM, DRAM, and/or other types of RAM), flash memory, secure digital (SD) memory, registers, compact discs (CD), digital video discs (DVD), and/or other types of non-transitory computer-readable mediums. A non-transitory computer-readable medium may include those computer-readable mediums that are not signals per se. Depending on the particular embodiment, these non-transitory computer-readable mediums may reside within the web hosting computing device 102b and/or external to the web hosting computing device 102b.

Additionally, the memory component 140 may be configured to store operating logic 242 and products logic 144. The operating logic 242 may include an operating system, basic input output system (BIOS), and/or other hardware, software, and/or firmware for operating the web hosting computing device 102b. The products logic 144 includes the comparison logic 144a, the cart window logic 144b, and the cross-sell logic 144c. The comparison logic 144a, the cart window logic 144b, and the cross-sell logic 144c may each include a plurality of different pieces of logic, each of which may be embodied as a computer program, firmware, and/or hardware, as an example. A local interface 246 is also included in FIG. 2 and may be implemented as a bus or other interface to facilitate communication among the components of the web hosting computing device 102b.

The processor 230 may include any processing component operable to receive and execute instructions (such as from the data storage component 236 and/or memory component 140). The input/output hardware 232 may include and/or be configured to interface with a monitor, positioning system, keyboard, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the web hosting computing device 102b and other computing devices. The processor 230 may also include and/or be coupled to a graphical processing unit (GPU).

It should be understood that the components illustrated in FIG. 2 are merely exemplary and are not intended to limit the scope of this disclosure. As an example, while the components in FIG. 2 are illustrated as residing within the web hosting computing device 102b, this is merely an example. In some embodiments, one or more of the components may reside external to the web hosting computing device 102b. It should also be understood that, while the web hosting computing device 102b in FIG. 2 is illustrated as a single device, this is also merely an example. In some embodiments, the comparison logic 144a, the cart window logic 144b, and the cross-sell logic 144c may reside on different devices. Additionally, while the web hosting computing device 102b is illustrated with the comparison logic 144a, the cart window logic 144b, and the cross-sell logic 144c as separate logical components, this is also an example. In some embodiments, a single piece of logic may perform the described functionality.

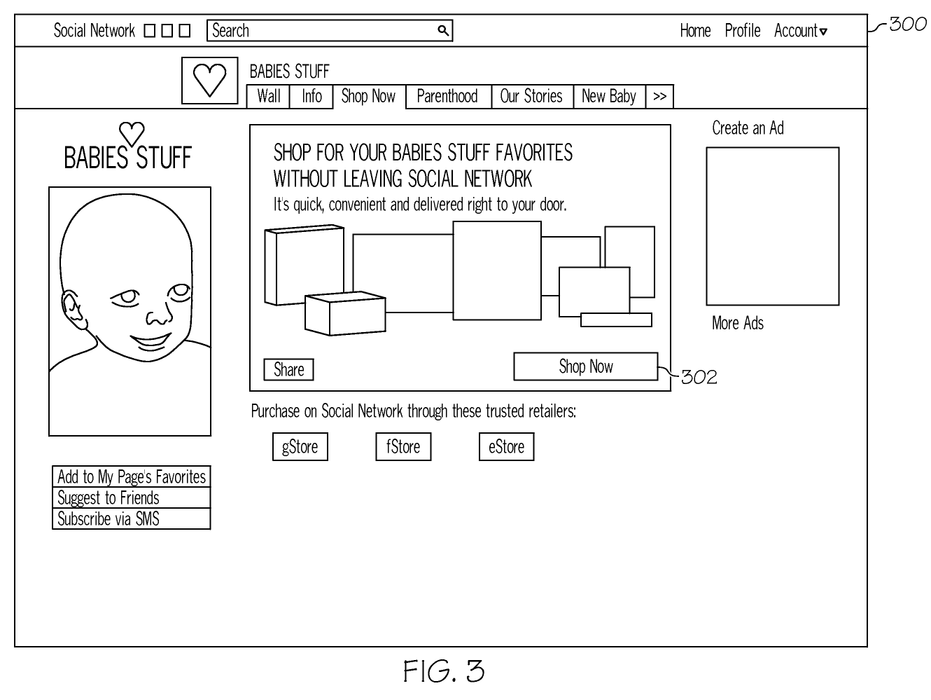

FIG. 3 depicts a product-user interface 300 for providing a product, according to embodiments disclosed herein. As illustrated, the product-user interface 300 may be directly imbedded within social networking website, a manufacturer website, an advertiser website, a third-party website and/or other website. In the social networking website, a manufacturer such as Pampers™ may have a manufacturer profile page dedicated to products that are related to that producer. Users of the social network may access the profile page to view and/or purchase products provided by the producer via selection of a shop now option 302.

As discussed herein a product may include any good and/or service that may be purchased as described herein. Examples of product types include household products, beauty and grooming products, and health and well-being products. Examples of household products may include Pampers™ diapers, Charmin™ toilet paper, Bounty™ paper towels, Tide™ detergent, Dawn™ dishwashing soap, Downy™ fabric softener, Duracell™ batteries, Mr. Clean™ cleaning products, Febreze™ fabric refresher, etc. Similarly, some examples of beauty and grooming products include Olay™ beauty products, Pantene™ shampoos and conditioners, Head and Shoulders™ shampoo, Covergirl™ beauty products, etc. Some examples of health and well-being products include Pringles™ potato crisps, Vicks™ cough syrup, Tampax™ tampons, Crest™ toothpaste etc. Other products and/or services are also included within the scope of this application.

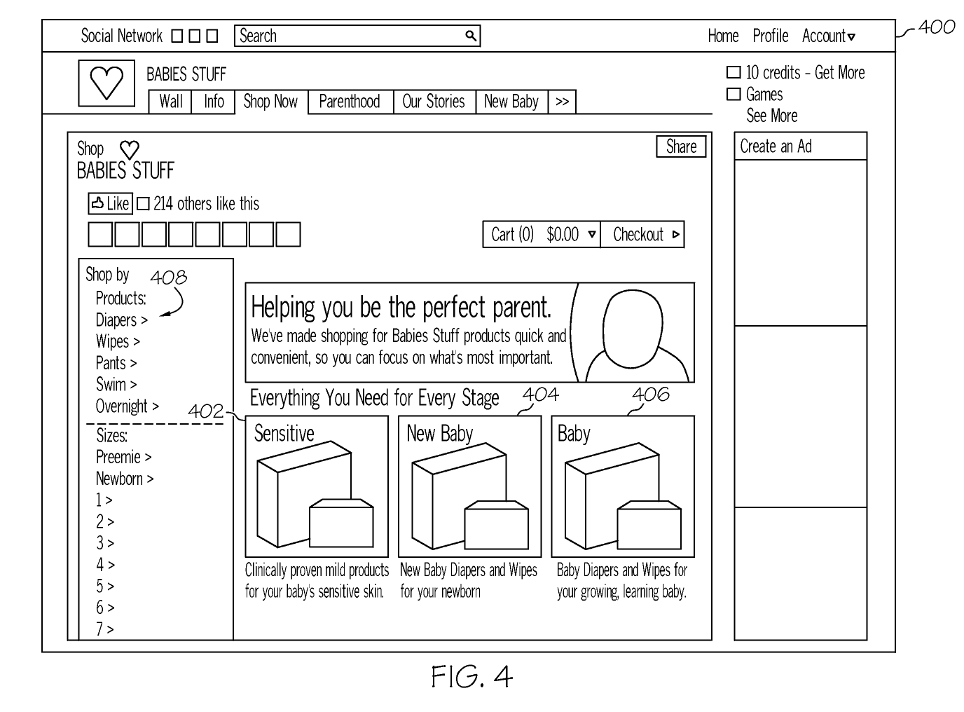

FIG. 4 depicts a product-user interface 400 for providing categories of products, according to embodiments disclosed herein. As illustrated, various products may be provided via options 402, 404, and 406. The product-user interface 400 also provides a “shop by” area, where users can filter products according to predetermined criteria. A diapers option 410 is provided within the shop by area.

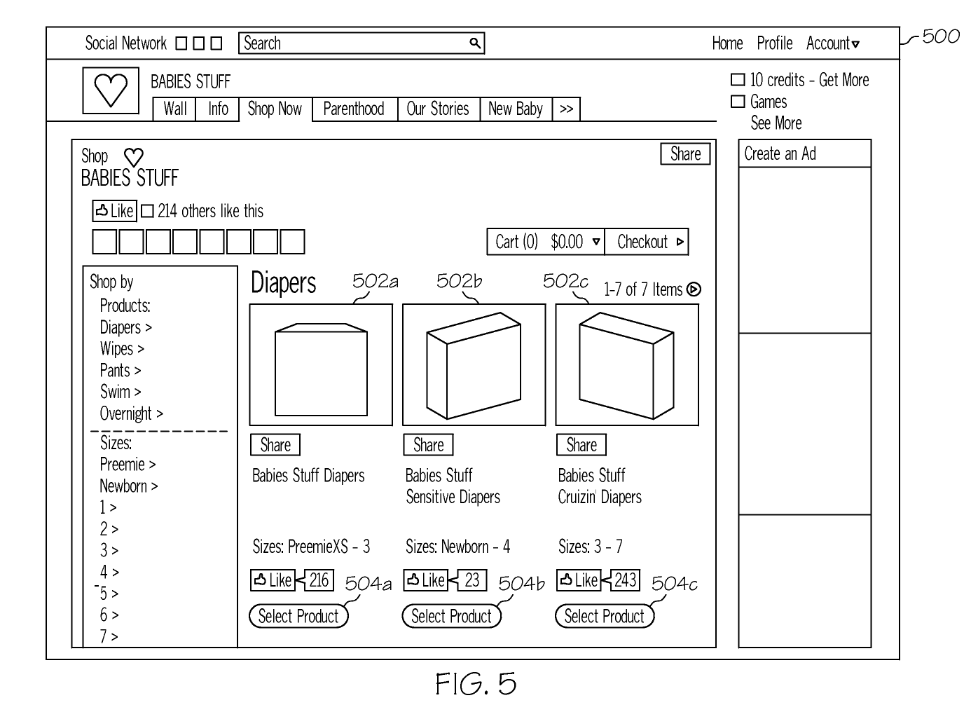

FIG. 5 depicts a product-user interface 500 for providing a plurality of products within a category, according to embodiments disclosed herein. As illustrated, in response to selection of the diapers option 410, a plurality of different products 502a, 502b, and 502c may be provided. Also included are options 504a, 504b, and 504c, which cause the web hosting computing device 102b to provide more information, as well as options to purchase.

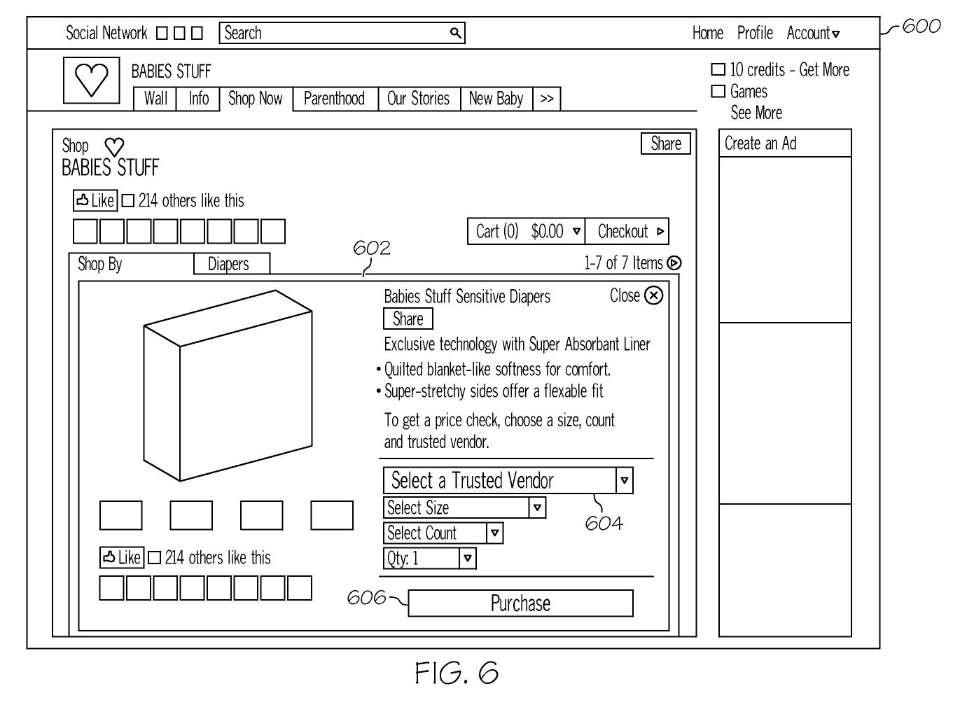

FIG. 6 depicts a product-user interface 600 for providing a purchase option 606 for purchasing a product, according to embodiments disclosed herein. As illustrated, the product-user interface 600 includes a product order window 602, which may be provided in response to selection of the option 504a, from FIG. 5. Within the product order window 602 is information related to the selected product, as well as sizing options, count options, quantity options, etc. Also included is a vendor list option 604. The vendor list option 604 provides a list of vendors and excludes vendors that do not currently maintain stock of the product. From the list of vendors, the user may indicate a selected vendor and then select the purchase option 606. Upon selecting the purchase option 606, the web hosting computing device 102b may facilitate purchase of the product without navigating to a website of the vendor.

As discussed in more detail below, the manufacturer (or other entity) may determine one or more vendors for providing the product depicted in the product order window 602. From a pool of vendors, the web hosting computing device 102b can access real-time inventory data of the product to determine whether each of the vendors currently stocks the product. The real-time inventory data may be collected by screen scraping a vendor website, contacting the vendor, screen scraping a manufacturer website, screen scraping an advertiser website, and/or by collecting the data via other similar mechanism. As used herein, screen scraping may include any mechanism for acquiring data from a user interface such as data fields, aesthetics, and/or other characteristics of the user interface.

If the web hosting computing device 102b determines that a vendor currently does not stock the product (a real-time determination), that vendor may be removed from consideration for this product. As a consequence, the web hosting computing device 102b may provide the vendor list in the vendor list option 604 without the removed vendor.

As discussed above, while one or more vendors may be removed from the vendor list based on a current stock of the product, this is merely an example. In some embodiments, vendors may be filtered from the vendor list based on any number of criteria, including filtering by current price threshold, by current price per unit threshold, by quantity, etc.

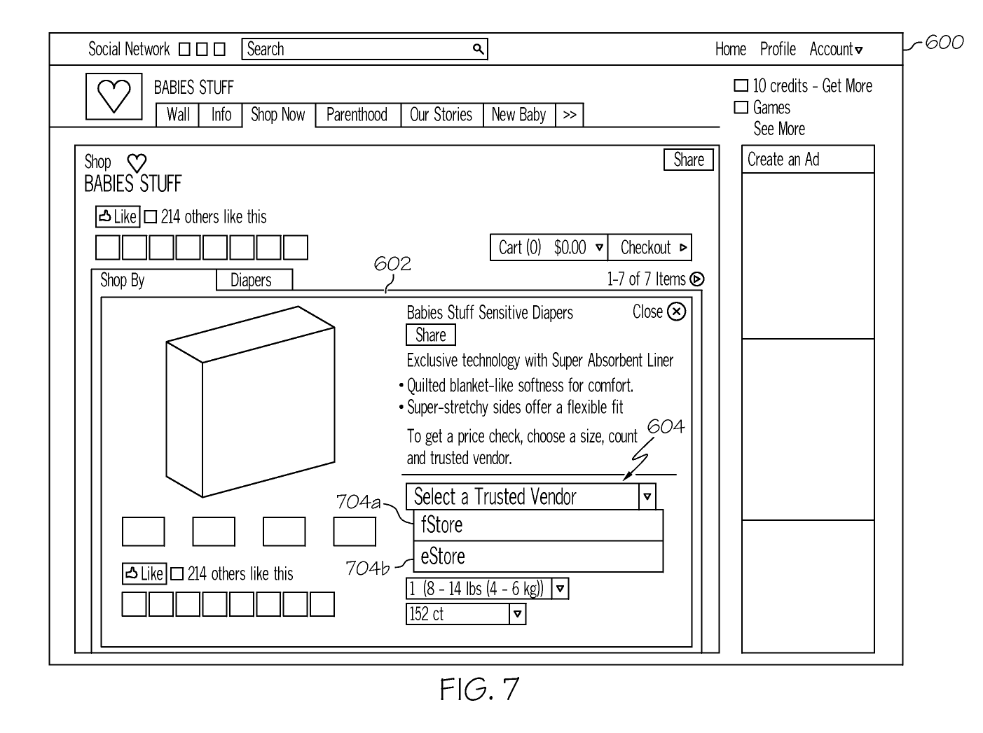

FIG. 7 depicts the product-user interface 600 (from FIG. 6) for providing a vendor option 704a, 704b when purchasing a product, according to embodiments disclosed herein. As illustrated, in response to selection of the vendor list option 604 from FIG. 6, a vendor list may be provided, which includes the vendor option 704a and the vendor option 704b. As discussed in more detail, below, the web hosting computing device 102b may determine which vendors currently stock the product depicted in the product order window 602. This list of vendors may be provided to the user for indicating a selected vendor. By selecting one of the vendor options 704a, 704b, a purchase of the product from that vendor may be facilitated.

While not explicitly depicted in FIG. 7, some embodiments may also provide comparison data related to the product form the various vendors provided in the vendor options 704a, 704b. More specifically, comparisons may be made according to price, a price per unit, shipping costs, shipping time, etc. With this data, the user may be more comfortable purchasing the product from one of the listed vendors.

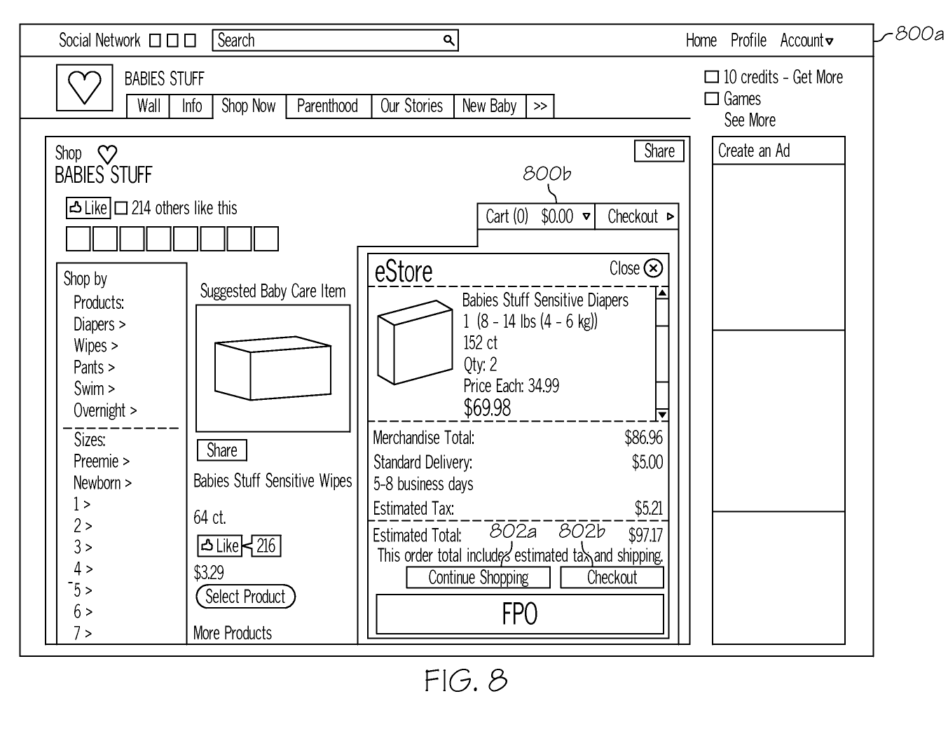

FIG. 8 depicts a product-user interface 800a for providing a cart window for purchasing a product, according to embodiments disclosed herein. As illustrated, in response to selection of one of the vendor options 704a, 704b from FIG. 7, the user may be provided with a cart window 800b. The cart window 800b may provide information related to one or more of the products that the user is currently purchasing. Also included in the cart window 800b is other information, such as shipping cost, shipping time, product details, price total, etc. The cart window 800b additionally includes a continue shopping option 802a and a cart option 802b.

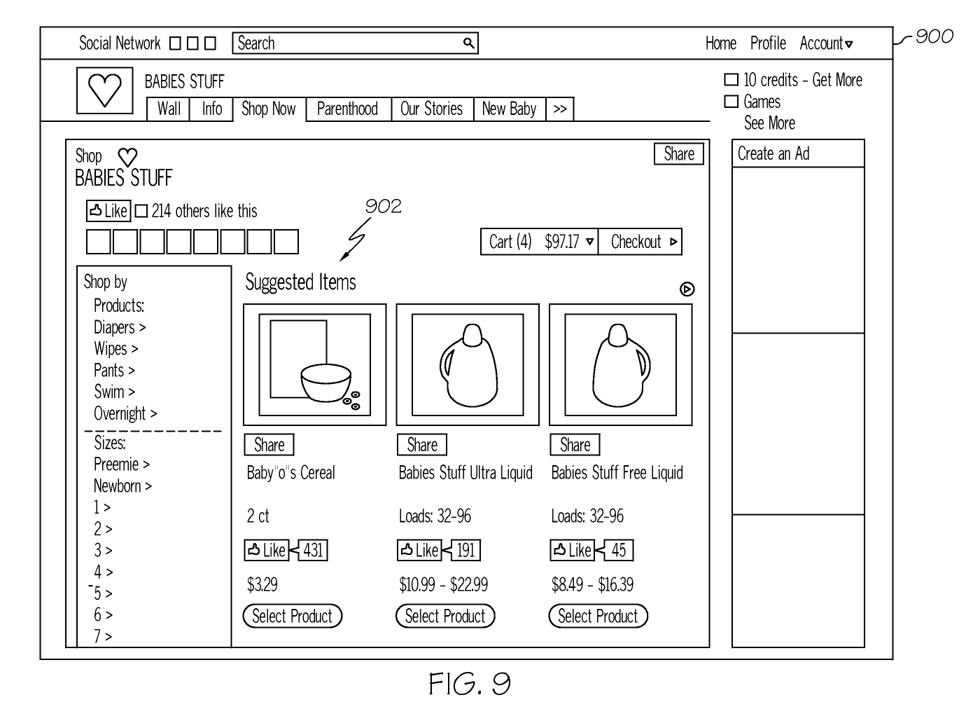

FIG. 9 depicts a product-user interface 900 for selecting a product for purchase, according to embodiments disclosed herein. As illustrated, the interface 900 provides one or more suggested products and/or promotions, based on one or more of the products that the user has viewed and/or purchased. As discussed in more detail below, the web hosting computing device 102b may determine a consumer characterization from one or more of the products viewed and/or purchased. The consumer characterization may include a current state of the consumer, such as a physical characteristic, an emotional characteristic, a cognitive characteristic, etc. From the consumer characterization, the web hosting computing device 102b can determine at least one product that a user with that consumer characterization may wish to purchase. While in some embodiments, the determined product may be in a similar product category as the viewed and/or purchased product, in some embodiments, the determined product may be in a different product category. Once this determination is made, real-time product data regarding the product (such as images, inventory status, and/or other data) may be collected from a website. The website may be a vendor website, a manufacturer website, and advertiser website, etc. The product data may be provided by itself and/or as a promotion for the product.

As an example, if a user has viewed and/or purchased the diapers from FIG. 8, the web hosting computing device 102b can determine that the user has a child of a certain age. The web hosting computing device 102b can additionally determine that the child will likely have certain a cognitive level, where choking is a concern and where allergies are a concern. As a result, the web hosting computing device 102b can recommend a choke resistant cereal, as well as allergen free detergents. This determination may be made based on any number of factors, including a cross-aisle sale statistic in a physical shopping facility. More specifically a physical shopping facility, such as a grocery store may determine cross-sell statistics of shoppers, which may be applied to this determination. Regardless, as both of these products are in a different product category than the viewed and/or purchased product (e.g. a food category and a cleaning category versus a child category), the user would not necessarily recognize the desire to purchase the determined products without this suggestion.

As another example, if a user is purchasing diapers for crawling children and then begins purchasing diapers for walking children, the web hosting computing device 102b may determine that the user has a child that is currently walking. As such, the web hosting computing device 102b can determine that the user was a walking child, and may then determine a cross-sell product, such as toddler walking shoes, which are a different category than the diapers. The toddler walking shoes may then be provided as a recommendation.

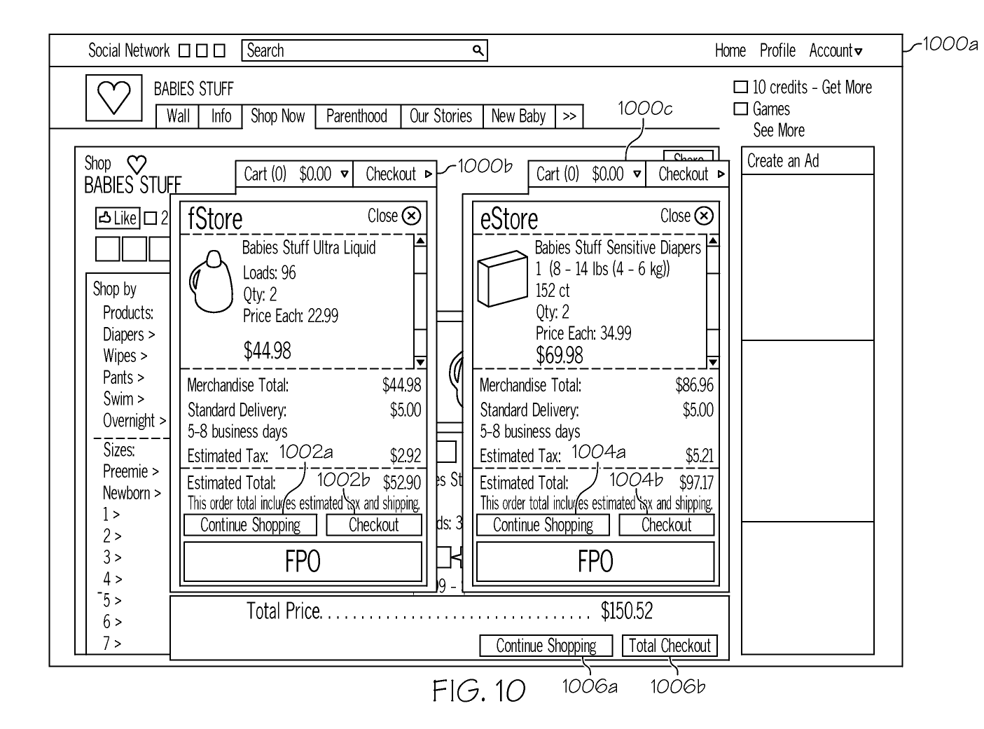

FIG. 10 depicts a product-user interface 1000a for providing a first cart window 1000b and a second cart window 1000c, according to embodiments disclosed herein. As illustrated, in some embodiments, a user may select a first product to be placed in a first cart window 1000b. The first product may be provided by a first vendor and may have been selected based on the vendor currently stocking the first product. Additionally, prior to finalizing purchase of the first product, the user may wish to purchase a second product. Due to price, stock, shipping time, and/or other criteria, the user may be unwilling or unable to purchase the second product from the first vendor. The user may however, be willing and/or able to purchase the second product from a second vendor. Accordingly, upon selection of a purchase option for the second product, a second cart window 1000c may be provided for purchasing the second product. The second cart window 1000c may be provided substantially concurrently as the first cart window 1000b. Additionally, the first cart window 1000b and the second cart window 1000c may be arranged according to price, a consumer preference of the first vendor and the second vendor, a previous purchase by consumers from the first vendor and the second vendor, and/or other criteria. Additional cart windows may be provided for additional purchases.

Once the first product is placed in the first cart window 1000b and/or the second product is placed in the second art window, the user may continue shopping by selecting a continue shopping option 1002a and/or 1004a. Additionally, if the user wishes to finalize purchase of the first product, the user may select a cart option 1002b; if the user wishes to finalize purchase of the second product, the user may select a cart option 1004b. Similarly, some embodiments include a third continue shopping option 1006a and a single cart option 1006b. The single cart option 1006b may facilitate purchase of all products that are placed in all of the cart windows 1000b, 1000c. As discussed in more detail below, this may provide the user with the ability to perform one checkout process for purchases with multiple vendors.

As an example, if the user selects a product that is placed in the first cart window 1000b, the web hosting computing device 102b can make a determination regarding a user purchase characteristic. The user purchase characteristic may be determined from products the user is currently viewing and/or purchasing, as well as products the user has previously viewed and/or purchased. The purchase characteristic may include (or be determined from) loyalty statistics related to the user's purchase of a manufacturer's products. Regardless, from the user purchase characteristic a second product may be determined for recommendation. The second product may be from a similar product category and/or from a different product category. The second product may be provided in a separate interface, may be automatically placed in the first cart window, and/or may be automatically placed into the second cart window 1000c. Additionally, the web hosting computing device 102b may determine a manufacturer provided (or vendor provided) promotion that may be applied if the user also purchases the recommended product. The promotion may include a coupons, free shipping, loyalty programs, etc. Depending on the particular embodiment, the promotions may be vendor specific or vendor independent.

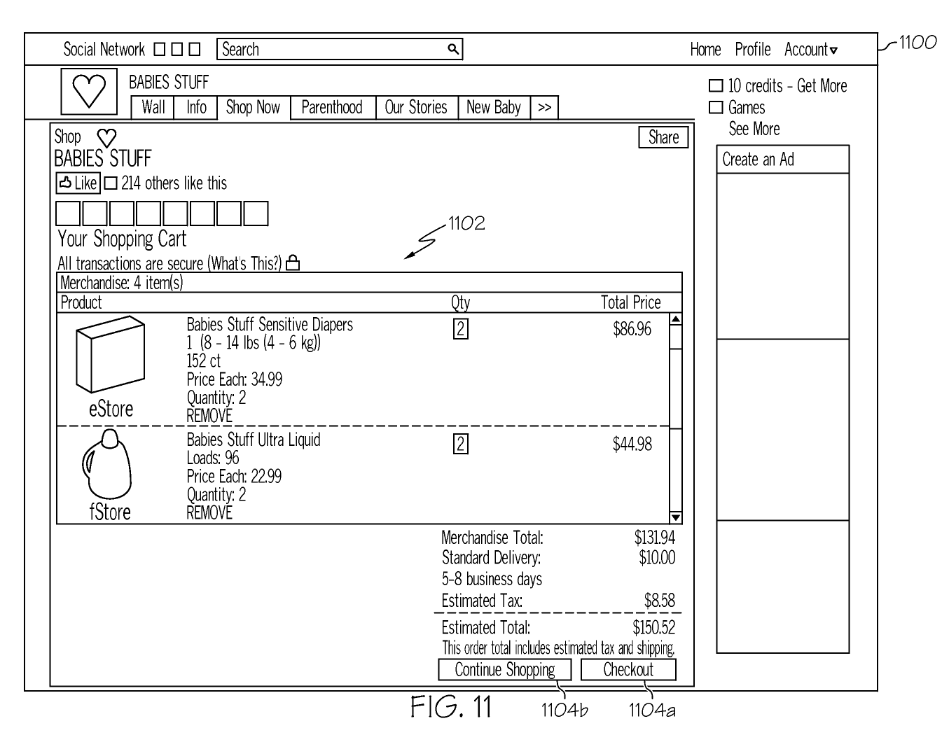

FIG. 11 depicts a product-user interface 1100 for providing a single shopping cart for a plurality of vendors, according to embodiments disclosed herein. As illustrated, in some embodiments, upon selecting a product for purchase, a single cart window 1102 may be provided. In such an embodiment, products from a plurality of different vendors may be purchased via a single checkout option 1104a. Also included is a continue shopping 1104b.

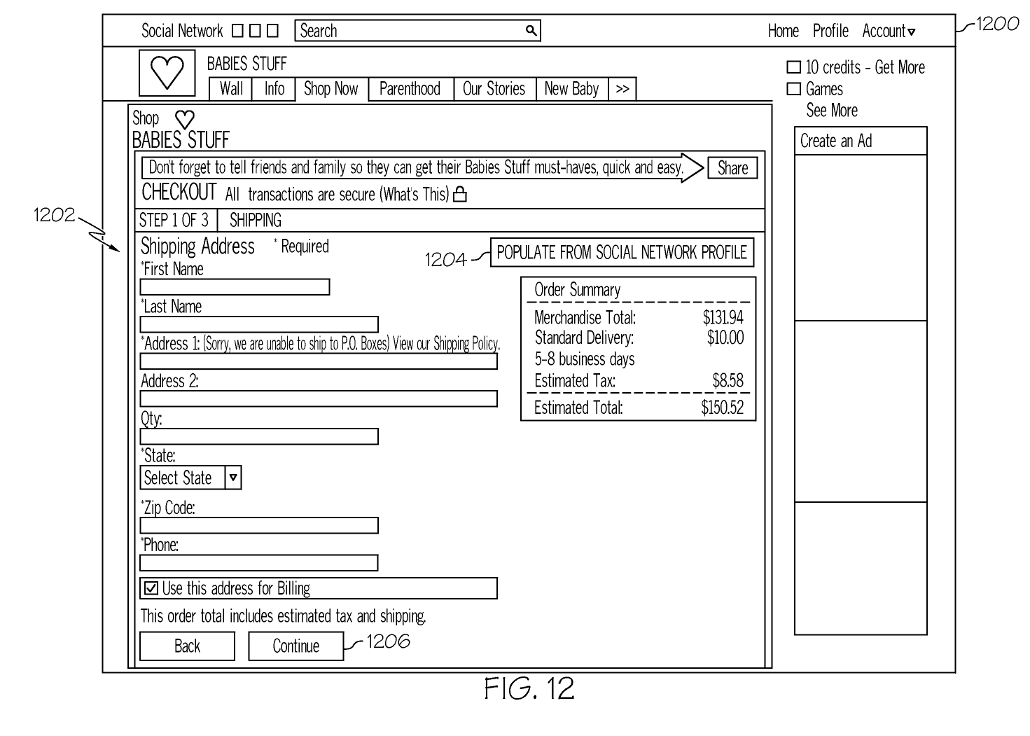

FIG. 12 depicts a product-user interface 1200 for receiving shipping information from a user, according to embodiments disclosed herein. As illustrated, after selecting one of the cart options 1002b, 1004b, 1006b (FIG. 10) and/or 1104a (FIG. 11), the user may be provided with an option 1202 to provide shipping and/or billing information. The option 1202 may include data that has been screen scraped, received from a daily feed, and/or otherwise retrieved from a vendor website that is providing the product. By screen scraping the data from the vendor website, there can be an assurance that the vendor is receiving all the desired user information. While this information may be manually entered, in some embodiments, the user may merely log into the social network, product website, etc., which has the desired information stored. Similarly, in embodiments where the product-user interface 1200 is part of a social network, in response to a user selection of a populate option 1204, at least a portion of the information may be retrieved from a user profile page of the user. This information may be stored for future purchases. Once the desired information has been received, the user may select a continue option 1206, to proceed.

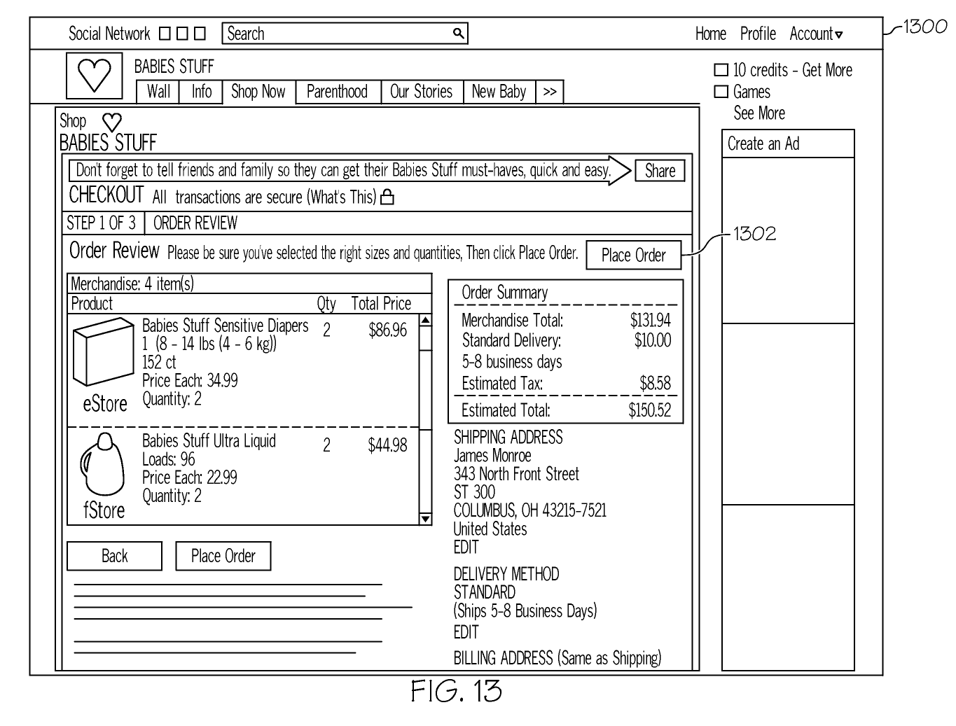

FIG. 13 depicts a product-user interface 1300 for placing an order for a product, according to embodiments disclosed herein. As illustrated, once the user information is entered in FIG. 12, the product-user interface 1300 may be presented, with a place order option 1302. Upon selecting the place order option 1302, the purchase of the product may be finalized.

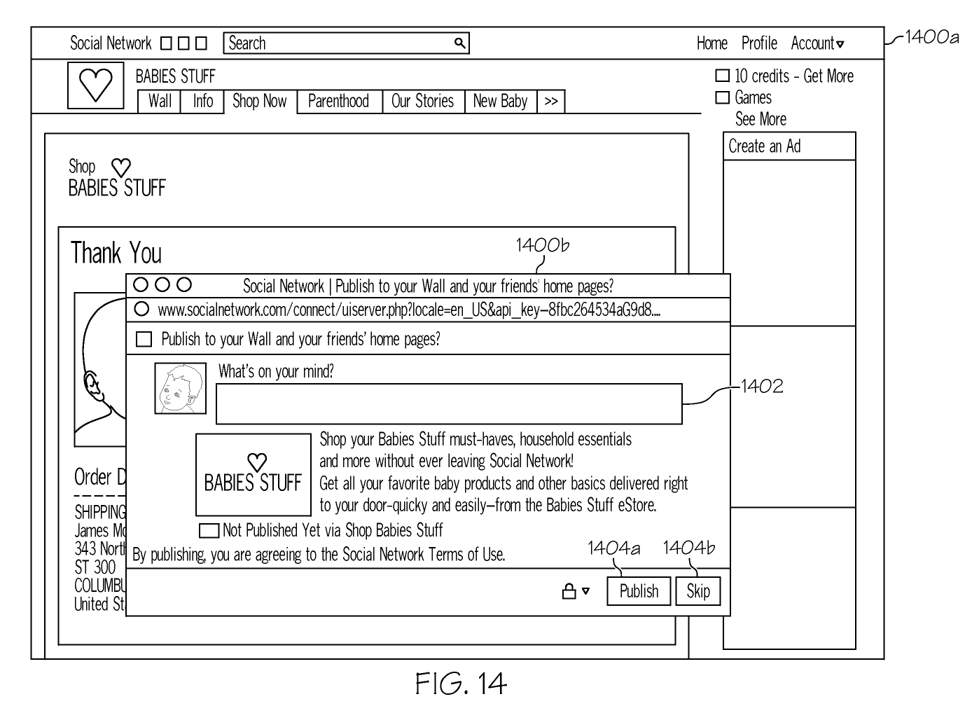

FIG. 14 depicts a product-user interface 1400 for publishing an advertisement on a webpage, according to embodiments disclosed herein. As illustrated, when the product-user interface 1400 is provided within a social network, the user may be presented with an option to publish information about the product on a user profile page of the user or friends of the user. The user may be presented with a text prompt, as well as a publish option 1404a to publish the information. A skip option 1404b may also be provided for not publishing the information.

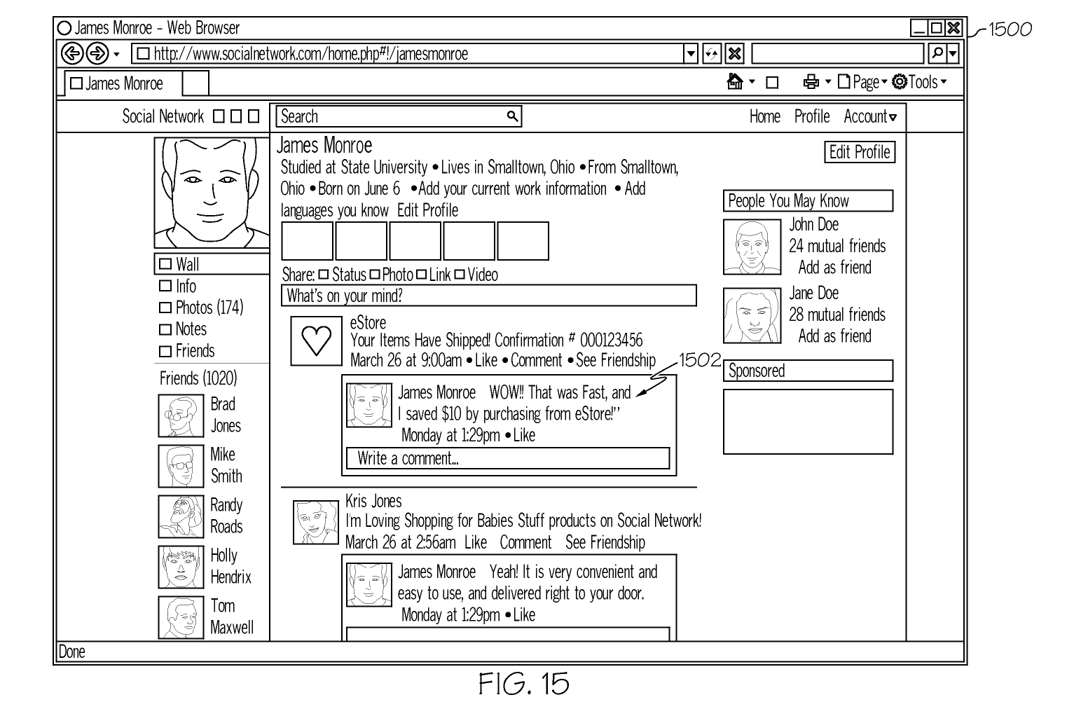

FIG. 15 depicts a user interface 1500 for posting a shipment notification in a public message, according to embodiments disclosed herein. As illustrated, in some embodiments, once the user has purchased a product, order confirmation information, shipment information, and/or other information may be provided in a post 1502 in a public forum of the social networking website. The public forum may be located on a public portion of a user profile page and/or other place that is accessible to the user. Similarly, in some embodiments, the order confirmation may be sent to an email address of the user, a mobile phone number as a text message to the user, and/or other private forum.

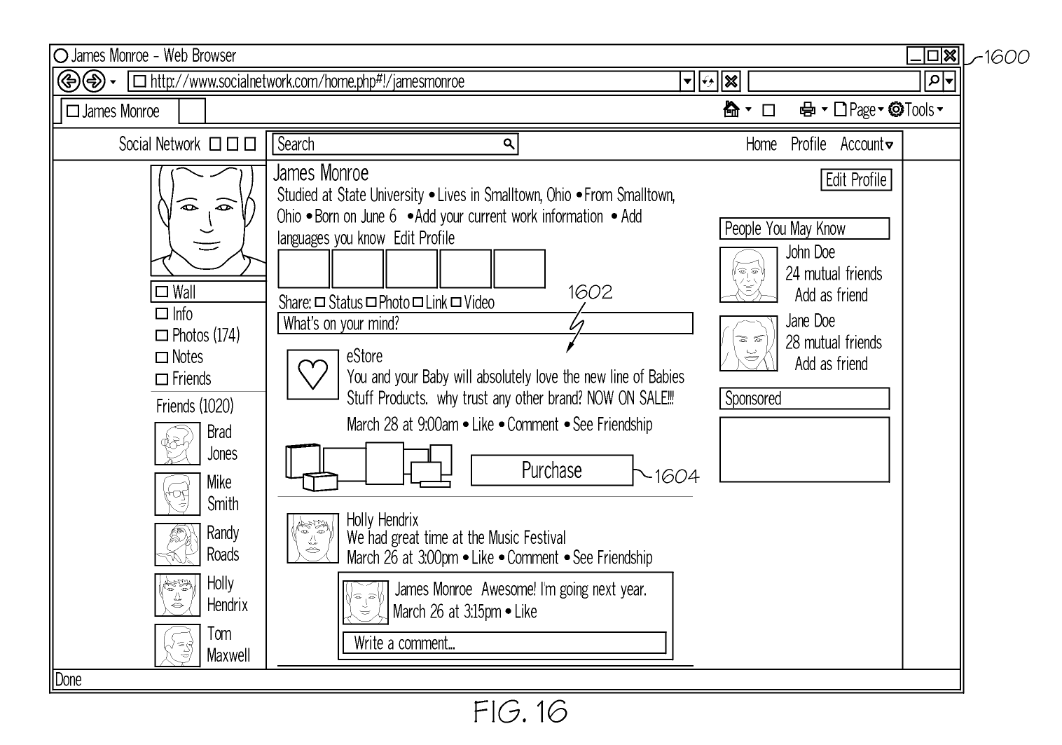

FIG. 16 depicts a user interface 1600 for providing a purchase option 1604 in a public message 1602, according to embodiments disclosed herein. As illustrated, in a social network, the user may purchase goods from the manufacturer website and/or become a friend of the manufacturer website. As such, the user may periodically receive advertisements from the manufacturer. The manufacturer may send mass advertisements and/or determine which products may be of interest to the user and send directed advertisements to the user. As an example, as the web hosting computing device 102b may be configured to determine a consumer characterization, the web hosting computing device 102b may then utilize this consumer characterization for future advertisements. This might include a projection of a future state of the consumer. From this future state, the web hosting computing device 102b can recommend products to the user.

More specifically, if the user purchases size 2 sneakers and six months later purchases size 3 sneakers, the web hosting computing device 102b may determine that the user will most likely wish to purchase size 4 sneakers six months later. As such, upon the six month anniversary of the second purchase, the manufacture (or other entity) may send an advertisement to the user for the size 4 sneakers. The advertisement may have a purchase option 1604, such that selection of the product from the public forum may launch a product order window, such as the product order window 602 (FIG. 6), which can being the ordering process, as depicted in FIGS. 6-14.

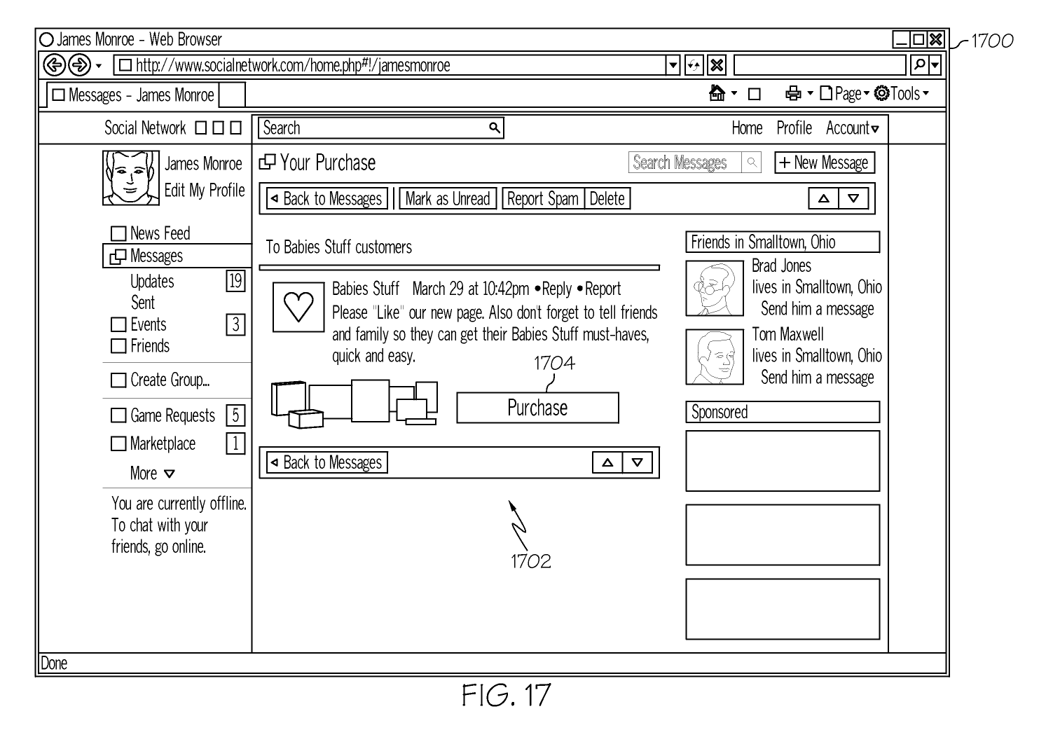

FIG. 17 depicts a user interface 1700 for providing a purchase option 1704 in a private message 1702, according to embodiments disclosed herein. As illustrated, the private message 1702 may be provided within a social networking profile of the user. Similar to the advertisements that may be provided in the public forum depicted in FIG. 16, the manufacturer, vendor, and/or other entity may also send advertisements as private messages on the social network. The advertisements provided within the private message may also include order options to further facilitate the ordering process.

Additionally, while not explicitly depicted in FIG. 17, order confirmations, shipping confirmations, etc. may also be provided in the private message forum. Such information may be provided in addition to or as a substitution for messages provided in the public message forum.

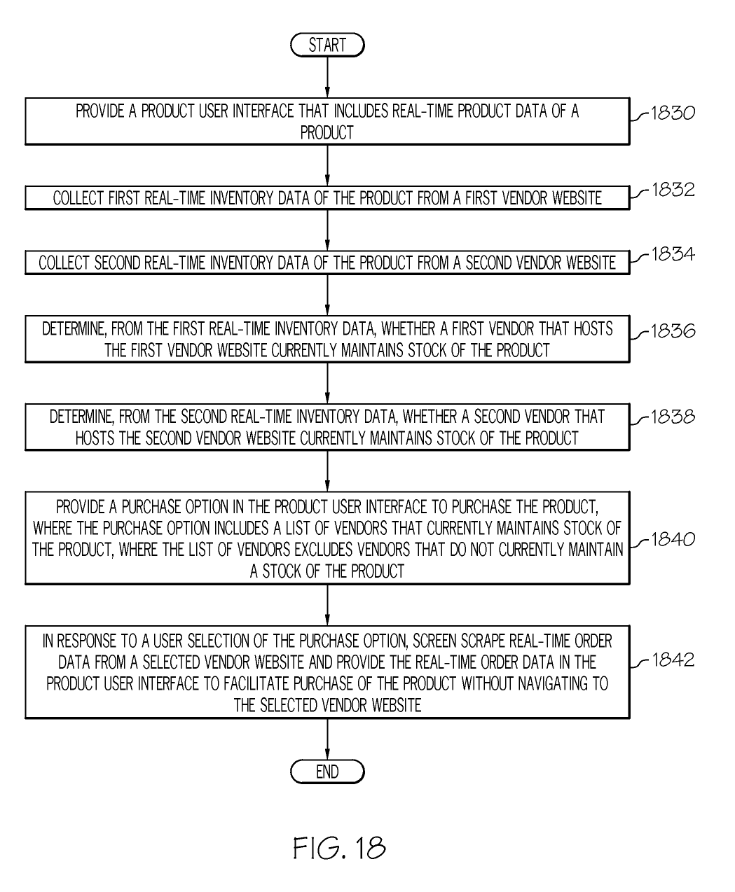

FIG. 18 depicts a flowchart for inventory comparison, according to embodiments disclosed herein. As illustrated at block 1830, a product-user interface may be provided to a user, where the product-user interface includes real-time product data of a product. At block 1832, first real-time inventory data of the product may be collected from a first vendor website. At block 1834, second real-time inventory data of the product from a second vendor website may be collected. At block 1836, a determination may be made from the first real-time inventory data, whether a first vendor that hosts the first vendor website currently maintains stock of the product. At block 1838, a determination may be made from the second real-time inventory data, whether a second vendor that hosts the second vendor website currently maintains stock of the product. At block 1840, a purchase option may be provided in the product-user interface to purchase the product, where the purchase option includes a list of vendors that currently maintains stock of the product, and where the list of vendors excludes vendors that do not currently maintain stock of the product. At block 1842, in response to a user selection of the purchase option, real-time order data may be screen scraped from a selected vendor website, received from a daily feed, and/or otherwise retrieved. Additionally, the real-time order data may be provided in the product-user interface to facilitate purchase of the product without navigating to the selected vendor website.

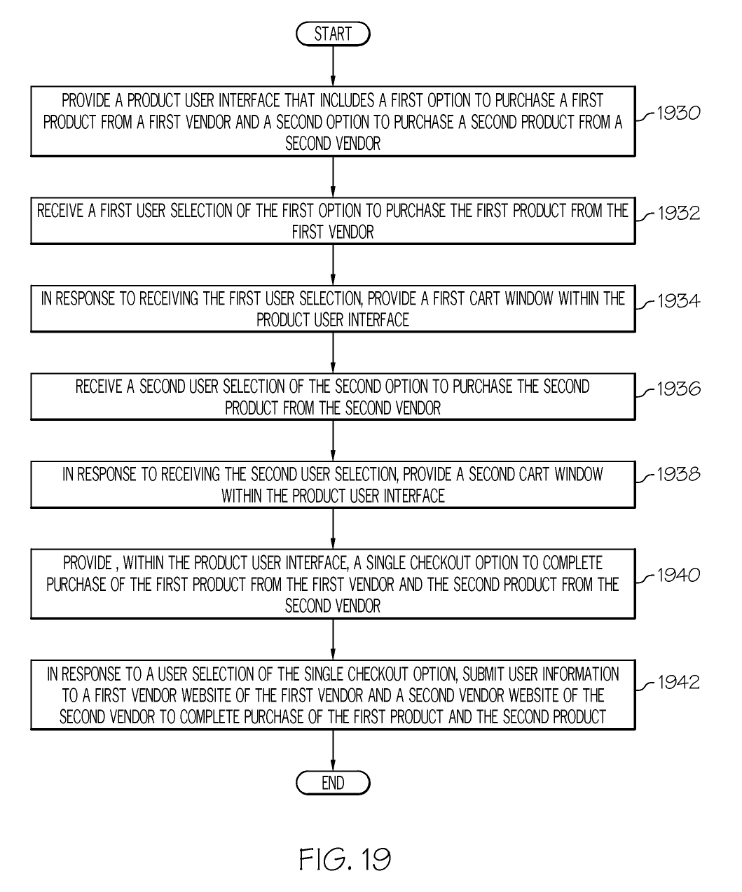

FIG. 19 depicts a flowchart for facilitating a purchase from a plurality of vendors, according to embodiments disclosed herein. As illustrated in block 1930, a product-user interface that includes a first option to purchase a product from a first vendor may be provided. Similarly, a second option to purchase a product from a second vendor may be provided. At block 1932, a first user selection of the first option to purchase the first product from the first vendor may be received. At block 1934, in response to receiving the first user selection, a first cart window 1000b may be provided within the product-user interface. At block 1936, a second user selection of the second option to purchase the second product from the second vendor may be received. At block 1938, in response to receiving the second user selection, a second cart window may be provided within the product-user interface. At block 1940, a single cart option may be provided within the product-user interface to complete purchase of the first product from the first vendor and the second product from the second vendor. At block 1942, in response to a user selection of the single cart option, user information may be submitted to a first vendor website of the first vendor and a second vendor website of the second vendor to complete purchase of the first product and the second product.

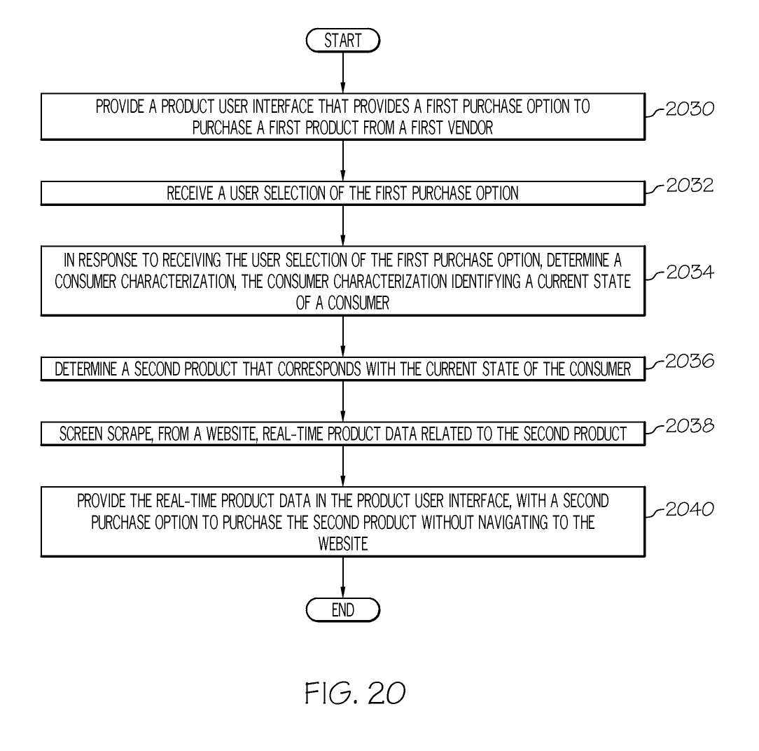

FIG. 20 depicts a flowchart for providing cross product recommendation, according to embodiments disclosed herein. As illustrated in block 2030, a product-user interface may be provided, where the product-user interface provides a first purchase option to purchase a first product from a first vendor. At block 2032, a user selection of the first purchase option may be received. At block 2034, in response to receiving the user selection of the first purchase option, a consumer characterization may be determined, where the consumer characterization identifies a current state of the consumer. At block 2036, a second product that corresponds with the current state of the consumer may be determined. At block 2038, real-time product data that is related to the second product may be screen scraped from a website, received from a daily feed, and/or otherwise retrieved. The website may be a vendor website, a manufacturer website and/or other website. At block 2040, the real-time product data may be provided in the product-user interface, with a second purchase option to purchase the second product without navigating to the website.

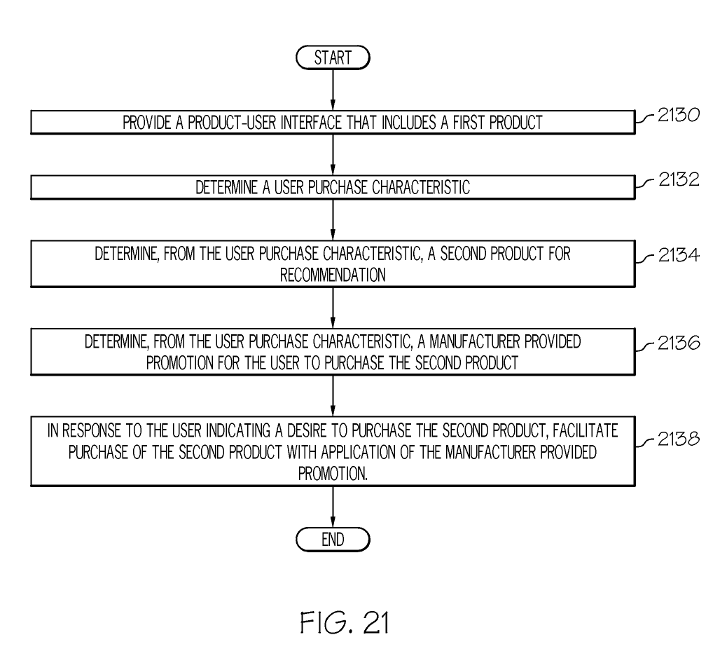

FIG. 21 depicts a flowchart for providing a product recommendation and promotion, according to embodiments disclosed herein. As illustrated in block 2130, a product-user interface may be provided, where the product-user interface includes a first product. At block 2132, a user purchase characteristic may be determined As discussed above, the user purchase characteristic may include a characteristic determined from products the user has viewed and/or purchased to determine what related or cross-sell products the user may have interest. Accordingly, at block 2134, a second product for recommendation may be determined from the purchase characteristic. At block 2136, a manufacturer provided promotion may be determined from the user purchase characteristic, where the promotion is for purchase of the second product. At block 2138, in response to the user indicating a desire to purchase the second product, purchase of the second product with application of the manufacturer provided promotion may be facilitated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A method for facilitating a purchase from a plurality of vendors, comprising:
providing a product-user interface that comprises a first option to purchase a first product from a first vendor and a second option to purchase a second product from a second vendor;
receiving a first user selection of the first option to purchase the first product from the first vendor;
in response to receiving the first user selection, providing a first cart window within the product-user interface;
receiving a second user selection of the second option to purchase the second product from the second vendor;
in response to receiving the second user selection, providing a second cart window within the product-user interface;
providing, within the product-user interface, a single checkout option to complete purchase of the first product from the first vendor and the second product from the second vendor; and
in response to a user selection of the single checkout option, submitting user information to a first vendor website of the first vendor and a second vendor website of the second vendor to complete purchase of the first product and the second product.

2. The method of claim 1, wherein the second cart window is provided substantially concurrently as the first cart window.

3. The method of claim 1, wherein the product-user interface further provides a promotion for at least one of the following, taken directly from a third-party website: the first product and the second product.

4. The method of claim 1, wherein the product-user interface is embedded directly within at least one of the following:
a manufacturer website;
a third-party website;
a private message within a social networking website;
a user profile page within the social networking website; and
a manufacturer profile page within the social networking website.

5. The method of claim 1, wherein the product-user interface is embedded directly within a social networking website and wherein facilitating purchase of the first product comprises retrieving personal information from a user profile page on the social networking website.

6. The method of claim 1, wherein the first cart window and the second cart window are arranged according to at least one of the following: price, a consumer preference of the first vendor and the second vendor, and a previous purchase by consumers from the first vendor and the second vendor.

7. The method of claim 1, further comprising:
receiving a first order confirmation from the first vendor and a second order confirmation from the second vendor; and
sending data related to the first order confirmation and the second order confirmation to at least one of the following:
an email address of a user,
a mobile phone number as a text message,
a private message forum on a social networking profile of the user, and
a public message forum on the social networking profile of the user.

8. The method of claim 1, wherein the first product is included in at least one of the following product types: household products, beauty and grooming products, and health and well-being products.

9. The method of claim 1, wherein the first product includes at least one of the following: diapers, toilet paper, paper towels, detergent, dishwashing soap, fabric softener, batteries, cleaning products, fabric refresher, beauty products, shampoos, conditioners, potato crisps, cough syrup, tampons, and toothpaste.

10. A non-transitory computer-readable medium for facilitating a purchase from a plurality of vendors that stores logic that, when executed by a computing device, causes the computing device to perform at least the following:
provide a product-user interface that comprises a first option to purchase a first product from a first vendor and a second option to purchase a second product from a second vendor;
receive a first user selection of the first option to purchase the first product from the first vendor;
in response to receiving the first user selection, provide a first cart window within the product-user interface;
receive a second user selection of the second option to purchase the second product from the second vendor;
in response to receiving the second user selection, provide a second cart window within the product-user interface;
provide, within the product-user interface, a first checkout option to complete purchase of the first product from the first vendor and a second checkout option to complete purchase of the second product from the second vendor;
in response to a user selection of the first checkout option, submit user information to a first vendor website of the first vendor to complete purchase of the first product; and
in response to a user selection of the second checkout option, submit user information to a second vendor website of the second vendor to complete purchase of the second product.

11. The non-transitory computer-readable medium of claim 10, wherein the second cart window is provided substantially concurrently as the first cart window.

12. The non-transitory computer-readable medium of claim 10, wherein the product-user interface further provides a promotion for at least one of the following, taken directly from a third-party website: the first product and the second product.

13. The non-transitory computer-readable medium of claim 10, wherein the product-user interface is embedded directly within at least one of the following:
a manufacturer website;
a third-party website;
a private message within a social networking website;
a user profile page within the social networking website; and
a manufacturer profile page within the social networking website.

14. The non-transitory computer-readable medium of claim 10, wherein the product-user interface is embedded directly within a social networking website and wherein facilitating purchase of the first product comprises retrieving personal information from a user profile page on the social networking website.

15. The non-transitory computer-readable medium of claim 10, wherein the first cart window and the second cart window are arranged according to at least one of the following: price, a consumer preference of the first vendor and the second vendor, and a previous purchase by consumers from the first vendor and the second vendor.

16. The non-transitory computer-readable medium of claim 10, wherein the logic further causes the computing device to perform at least the following:
receive a first order confirmation from the first vendor and a second order confirmation from the second vendor; and
send data related to the first order confirmation and the second order confirmation to at least one of the following:
an email address of a user,
a mobile phone number as a text message,
a private message forum on a social networking profile of the user, and
a public message forum on the social networking profile of the user.

17. The non-transitory computer-readable medium of claim 10, wherein the first product is included in at least one of the following product types: household products, beauty and grooming products, and health and well-being products.

18. The non-transitory computer-readable medium of claim 10, wherein the first product includes at least one of the following: diapers, toilet paper, paper towels, detergent, dishwashing soap, fabric softener, batteries, cleaning products, fabric refresher, beauty products, shampoos, conditioners, potato crisps, cough syrup, tampons, and toothpaste.

19. A system for facilitating a purchase from a plurality of vendors, comprising:
a memory component that stores logic that, when executed by the system, causes the system to perform at least the following:
provide a product-user interface that comprises a first option to purchase a first product from a first vendor and a second option to purchase a second product from a second vendor;
receive a first user selection of the first option to purchase the first product from the first vendor;
in response to receiving the first user selection, provide a first cart window within the product-user interface;
receive a second user selection of the second option to purchase the second product from the second vendor;
in response to receiving the second user selection, provide a second cart window within the product-user interface; and
provide a first checkout option to complete purchase of the first product from the first vendor and a second checkout option to complete purchase of the second product from the second vendor.

20. The system of claim 19, wherein the logic further causes the system to perform at least the following:
in response to a user selection of the first checkout option, submit user information to a first vendor website of the first vendor to complete purchase of the first product; and
in response to a user selection of the second checkout option, submit user information to a second vendor website of the second vendor to complete purchase of the second product.

21. The system of claim 19, wherein the second cart window is provided substantially concurrently as the first cart window.

22. The system of claim 19, wherein the product-user interface is embedded directly within at least one of the following:
a manufacturer website;
a third-party website;
a private message within a social networking website;
a user profile page within the social networking website; and
a manufacturer profile page within the social networking website.

23. The system of claim 19, wherein the first cart window and the second cart window are arranged according to at least one of the following: price, a consumer preference of the first vendor and the second vendor, and a previous purchase by consumers from the first vendor and the second vendor.

24. The system of claim 19, wherein the logic further causes the system to perform at least the following:
receive a first order confirmation from the first vendor and a second order confirmation from the second vendor; and
send data related to the first order confirmation and the second order confirmation to at least one of the following:
an email address of a user,
a mobile phone number as a text message,
a private message forum on a social networking profile of the user, and
a public message forum on the social networking profile of the user.

25. The system of claim 19, wherein the first product is included in at least one of the following product types: household products, beauty and grooming products, and health and well-being products.

26. The system of claim 19, wherein the first product includes at least one of the following: diapers, toilet paper, paper towels, detergent, dishwashing soap, fabric softener, batteries, cleaning products, fabric refresher, beauty products, shampoos, conditioners, potato crisps, cough syrup, tampons, and toothpaste.
